(19) United States
(12) Patent Application Publication
(10) Pub. No.: US 2026/0242157 A1
(43) Pub. Date: Aug. 20, 2026

(54) FERROMAGNETIC LYOBEAD HANDLING

(71) Applicant: ATS Corporation, Cambridge (CA)

(72) Inventors: Curtis CALLEJA, Cambridge (CA); Nico SINNIGE, Cambridge (CA); Kevin TANAKA, Cambridge (CA); Chris SCHMID, Cambridge (CA)

(21) Appl. No.: 19/471,266

(22) PCT Filed: Mar. 28, 2024
(86) PCT No.: PCT/CA2024/050397

§ 371 Date: Sep. 30, 2025

Related U.S. Application Data
(60) Provisional application No. 63/456,397, filed on Mar. 31, 2023.

(51) Int. Cl. B65G 47/92; B65G 47/90

(52) U.S. Cl. CPC B65G 47/92; B65G 47/901; B65G 2201/02

(57) ABSTRACT

An automated handling system for ferromagnetic lyobeads can include a plurality of quills that have tips to at least partially receive the ferromagnetic lyobeads. At least one of the quills can include a controllable magnet that can be controlled to vary a magnetic force at the tip of the quill in order to controllably retain or release one of the ferromagnetic lyobeads from the tip.

### RELATED APPLICATIONS

The current application claims priority to U.S. Provisional Patent Application 63/456,397, entitled “Ferromagnetic Lyobead Handling,” and filed Mar. 31, 2023, the entire contents of which are incorporated herein in their entirety for all purposes.

### TECHNICAL FIELD

The current disclosure relates to handling of lyobeads and in particular to handling ferromagnetic lyobeads in an automated, or semi-automated manner.

### BACKGROUND

Lyophilization, commonly known as freeze-drying, is a widely used process for the preservation of biologics, pharmaceuticals, and other sensitive materials. In lyophilization, the material to be preserved is first frozen and then subjected to a vacuum, which removes the water from the material without causing damage to its structure. Once the material is dried, it is typically stored in a lyophilized state, which can extend its shelf life and improve its stability.

One approach to lyophilization involves the use of lyophilization beads, or lyobeads. Lyobeads are small spheres of customisable, lyophilised material. Unlike traditional lyophilised formats, each individual bead may contain a single, accurately measured dose of the lyophilised material. The lyophilised material typically is comprised of a reagent or pharmaceutical together with one or more excipients. The excipients can include salts, oxides, stabilizers, delivery liquids and other similar components some of which may have ferromagnetic properties.

Lyobeads can be difficult to handle since they are typically very small, and their high surface area can make them prone to clumping together or sticking to surfaces. Additionally, the lyobeads can be fragile and easily damaged.

An additional, alternative and/or improved system and method for handling certain lyobeads is desirable.

### BRIEF DESCRIPTION OF THE DRAWING

Further features and advantages of the present disclosure will become apparent from the following detailed description, taken in combination with the appended drawings, in which:

FIG. 1A-1F depict a system and operation for handling of ferromagnetic lyobeads;

FIGS. 2A and 2B depict a magnetic moveable quill;

FIG. 3A-3D depict a further magnetic moveable quill;

FIG. 4A-4E depict different profiles of a quill;

FIG. 5A-5C depict a system and operation for handling of ferromagnetic lyobeads with a magnetic lower quill;

FIG. 6A-6C depict a system and operation for handling of ferromagnetic lyobeads with a magnetic lower quill;

FIG. 7 depicts a further system for handling of ferromagnetic lyobeads;

FIG. 8 depicts a method for handling of ferromagnetic lyobeads;

FIG. 9 depicts a further system for handling ferromagnetic lyobeads; and

FIG. 10 depicts an assembly line system incorporating a magnetic lyobead handler.

### DETAILED DESCRIPTION

In accordance with the present disclosure there is provided a handling system for ferromagnetic lyobeads comprising: a singulation bowl for holding a plurality of ferromagnetic lyobeads, the singulation bowl comprising an opening in a bottom of the singulation bowl; a lower quill arranged to pass through the opening of the singulation bowl and comprising a tip shaped to allow a ferromagnetic lyobead of the plurality of ferromagnetic lyobeads in the singulation bowl to rest on the tip when the lower quill passes through the opening of the singulation bowl; and an upper quill comprising: a tip shaped to at least partially contact the ferromagnetic bead on the lower quill; and a controllable magnet within the tip that is controllable to provide a magnetic force at the tip of the upper quill that can retain the ferromagnetic lyobead against the tip of the upper quill.

In a further embodiment of the handling system, the handling system further comprises a first actuator for moving the tip of the upper quill along a first axis.

In a further embodiment of the handling system, the first axis is towards/away the lower quill.

In a further embodiment of the handling system, the first actuator comprises a linear actuator.

In a further embodiment of the handling system, the handling system further comprises a second actuator for moving the upper quill along a second axis.

In a further embodiment of the handling system, the second axis moves the upper quill away/towards the lower quill.

In a further embodiment of the handling system, the lower quill comprises a magnet capable of providing a magnetic force tending to retain the ferromagnetic lyobead on the top of the lower quill.

In a further embodiment of the handling system, the magnet of the lower quill is controllable to vary the strength of the magnetic field at the top of the lower quill.

In a further embodiment of the handling system, the controllable magnet of the upper quill comprises an electromagnet arranged in the tip of the upper quill

In a further embodiment of the handling system, the controllable magnet of the upper quill comprises a moveable permanent magnet moveable towards/away from the tip of the upper quill.

In a further embodiment of the handling system, the handling system further comprises a linear actuator for moving the permanent magnet in the upper quill.

In a further embodiment of the handling system, the handling system further comprises an ionizer arranged to direct an air flow towards the ferromagnetic lyobead when captured on the lower quill.

In accordance with the present disclosure there is further provided a quill for use in an automated handling system of ferromagnetic lyobeads, the quill comprising: a tip shaped to contact at least part of a ferromagnetic lyobead; and a controllable magnet arranged to provide a variable strength magnetic field at the tip, the magnetic field variable between: a first strength sufficient to retain the ferromagnetic lyobead in contact with the tip; and a second strength insufficient to retain the ferromagnetic lyobead in contact with the tip.

In a further embodiment of the quill, the controllable magnet comprises an electromagnet arranged in the tip of the quill

In a further embodiment of the quill, the controllable magnet comprises a moveable permanent magnet moveable towards and away from the tip of the quill.

In a further embodiment of the quill, the quill further comprises a first linear actuator for moving the permanent magnet towards and away from the tip of the quill.

In a further embodiment of the quill, the quill further comprises a second linear actuator for moving the tip along a first axis.

In accordance with the present disclosure there is further provided a method of controlling an automated handling system for ferromagnetic lyobeads, the method comprising: controlling a lower quill of the automated handling system to pass through a singulation bowl of the handling system in order to capture a ferromagnetic lyobead within the singulation bowl on a top of the lower quill; bring the lower quill with the ferromagnetic lyobead into close proximity with an upper quill of the automated handling system; controlling a magnet of the upper quill of the automated handling system to provide a magnetic force at the tip of the upper quill sufficient to retain the ferromagnetic lyobead on the upper quill; moving the upper quill to a deposit position; and controlling the magnet of the upper quill to reduce the strength of the magnetic field in order to release the ferromagnetic lyobead from the upper quill.

In a further embodiment of the method, the method further comprises: controlling a magnet of the lower quill to retain the lyobead on the lower quill and release the ferromagnetic lyobead from the lower quill.

In accordance with the present disclosure there is further provided a non-transitory computer readable medium storing instructions which when executed configure a processor to provide a method according to the method as described above.

Automated, or semi-automated, handling of material or components can involve various process for moving material or parts through an assembly process, or other process. For example, materials or components may be picked from a first location and placed in a second location. Other processes and manipulations of the materials or components are possible.

Depending upon the material or components, how the handling is achieved may vary. The handling may include various grippers or actuators for picking, moving, manipulating and/or placing the material or components. For example, for large solid components a mechanical gripper may be used to pick and place the component. Vacuum suction devices may be used if the size, shape and material of the component be picked provides for consistent suction contact.

Lyobeads formed with a ferromagnetic component can be problematic for handling with mechanical grippers given their size and fragility which could crumble under the gripper. Additionally, if the lyobeads are provided to the automated handling system in a group, they will need to separated in order to be picked up by the mechanical gripper.

A vacuum actuator may be used to pick up individual lyobeads, however use of a vacuum can be problematic based on the size and/or composition of the lyobeads. The shape of lyobeads may have a near spherical tear drop shape of varying size which makes obtaining a reliable vacuum seal difficult. Additionally, depending upon the composition of the lyobead, hazardous dust may be generated and need to be handled accordingly. Further, the vacuum can create a static charge and debris shedding from the lyobead can cake the tubing and filter, which would be unfavorable for maintenance.

As described in detail further below, ferromagnetic lyobeads may be handled by a system that uses a selectably controllable magnet on an upper quill to pick the ferromagnetic lyobead from a lower quill and place it at a particular location. The lower quill can extend up through a singulation bowl that holds a plurality of the ferromagnetic lyobeads in order to capture a single lyobead on the lower quill that can then be transferred to the upper quill for subsequent placement. The use of the selectably controllable magnetic quill allows for picking and placing individual ferromagnetic lyobeads.

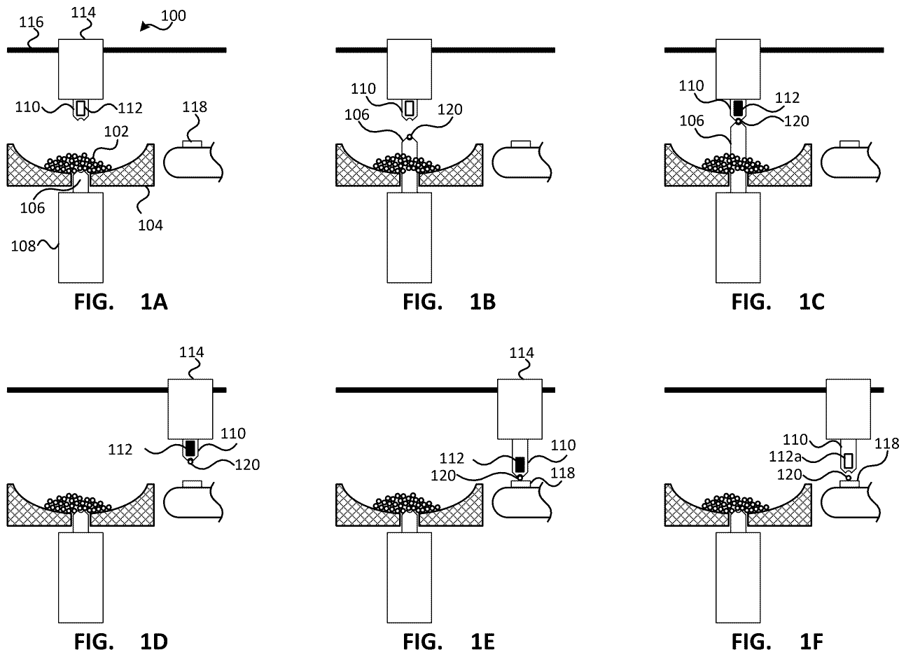

FIG. 1A-1F depict a system and operation for handling of ferromagnetic lyobeads. FIG. 1A depicts a handling system 100 for ferromagnetic lyobeads (referred to below as lyobeads for brevity) 102. The lyobeads are held in a singulation 104 bowl that can hold a plurality of the loose lyobeads. Note that the singulation bowl 104 is depicted in cross-section. The singulation bowl has an opening in the bottom through which a lower quill can extend as depicted in FIG. 1B. The lower quill 106 can be extended and retracted by way of an actuator 108 which may be provided in various ways including using linear actuators, rotary actuators, etc. The actuators may be operated electrically, pneumatically, and/or hydraulically.

The system 100 includes an upper quill 110 that has a selectably controllable magnet 112 in the quill. The magnet 112 can be controlled in order to provide a magnetic force at the surface of the upper quill that is sufficient to retain the lyobead on the upper quill. This is depicted in FIGS. 1C-1E as the black filled magnet 112. The magnet can be further controlled in order to remove the magnetic force at the surface of the upper quill so that the lyobead is no longer retained on the surface by the magnetic force. This is depicted in FIGS. 1A, 1B, 1F by the white filled magnet 112. The upper quill can be mounted to an actuator 114 that can move the quill 110. The actuator 114 is depicted as being mounted to a linear rail system 116 in order to move the actuator 114 and quill 110 to a placement location 118. The placement location 118 is depicted as being a plate 118 located on a conveyor system. The placement location 118 can be a particular location in a housing, package, etc. or can be a particular location in space such as placing the lyobead on a subsequent lyobead handling device. Although depicted as being on a linear rail 116, the actuator may be provided in various ways including a linear motor conveyors such as SuperTrak CONVEYANCE™ provided by ATS Automation Tooling Systems Inc., articulated arms, rotary arms, or other controlled motion devices or systems.

As depicted in FIG. 1C, the lower quill is extended up through the opening in the singulation bowl 104 and captures a single lyobead 120 on the top surface of the lower quill 106. The upper quill 110 is positioned by the actuator 114 above the lower quill. The lower quill 106 is extended towards the upper quill until the lyobead on the lower quill is in close proximity, and possibly in close contact, with the upper quill 110. Once the lyobead is in close proximity or contact with the upper quill, the controllable magnet is controlled in order to apply a magnetic force, depicted by the black magnet 112, that is sufficient to retain the lyobead against the surface of the upper quill.

As depicted in FIG. 1D, once the lyobead has been transferred from the lower quill 106 to the upper quill 110, the upper quill can be moved towards the placement position 118. Further, the lower quill 106 can be retracted below the lyobeads 102 in the singulation bowl 104. Once the upper quill, and the retained lyobead, are arranged over the placement position 118 the upper quill 110 can be lowered towards the placement location 118 until the lyobead is at the desired or required placement location as depicted in FIG. 1E. As depicted in FIG. 1F once the lyobead is at the placement location, the controllable magnet can be controlled in order to remove the retaining magnetic force so that the lyobead is placed at the placement location 118. The upper quill and actuator can then return to the location above the lower quill as depicted in FIG. 1A in order to pick another lyobead.

The above has described movement of various parts, such as the lower quill extending/retracting through the singulation bowl towards the upper quill. It will be appreciated that although described with regard to a specific component moving relative to another component, the relative movement of the components can be achieved by moving the other component while holding the first stationary, or moving both components relative to each other. For example, rather than extending the lower quill up through the singulation bowl, the lower quill may be held stationary and the singulation bowl lowered over down over the quill. Similarly the upper quill could be moved towards the stationary lower quill.

The system 100 uses a controllably magnetic quill in order to transfer a lyobead from a singulation location, that is a location in which a single lyobead can be repeatedly positioned, to a moveable quill and then to a placement location. The use of the controllable magnetic quill is described above within a particular system that uses a lower quill passing through a singulation bowl in order to place a single lyobead on the lower quill which can then reliably place the lyobead in the singulation location for transfer to the upper quill. While the controllably magnetic quill is advantageous in such a system, the controllably magnetic quill may also be used in other systems.

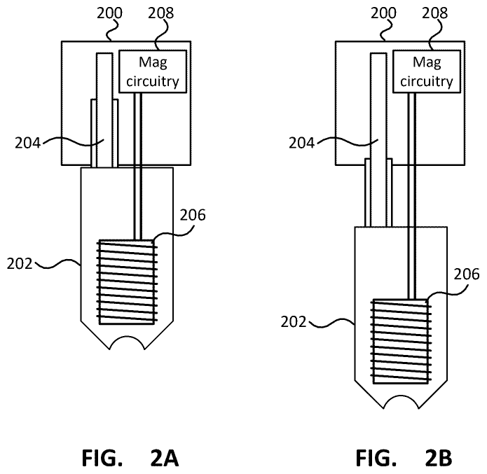

FIGS. 2A and 2B depict a magnetic moveable quill. The magnetic moveable quill 200 may be used as the upper quill 110 or possibly the lower quill 106 of FIGS. 1A-1F. The magnetic moveable magnetic quill 200 may be mounted to other actuators in order to position the magnetic moveable quill through desired locations. The magnetic moveable quill 200 comprises the quill itself 202 which may be made from a wide range of materials and may depend upon the composition of the lyobeads. One material that was found to provide acceptable performance was Semitron® ESD 520 of Mitsubishi Chemicals Advanced Materials. The quill may have a tip shape that is designed to help with the retention of the lyobead in a repeatable position. The quill 202 can be mounted to a linear actuator 204 that allows the quill to retract, as depicted in FIG. 2A, and extend, as depicted in FIG. 2B. Although depicted as a linear actuator 204, the quill movement may be provided by other actuators.

In addition to the actuator to move the quill 202 as depicted in FIGS. 2A, 2B, the moveable magnetic quill 200 also includes a controllable magnet arranged at the tip of the quill. The controllable magnet is depicted as an electric magnet that is depicted as a wire coil surrounding a ferrous core 206. The wire is connected to electric magnet circuitry 208 that can supply electricity to the wire coil in order to generate a magnetic force. The strength of the magnetic field at the tip of the quill can be controlled by turning on or off the power supplied to the coil. Additionally or alternative, the strength of the magnetic field may be varied by adjusting the current supplied to the coil. The magnet circuitry 208 can be located in or on the magnetic moveable quill 200, or possibly the quill itself. Alternatively, the circuitry 208 may be located in or on different components of the system the magnetic moveable quill 200 is used in.

The electric magnet may be controlled to provide a magnetic field of varying strength, which may allow the magnetic moveable quill 200 to be adapted to varying applications with lyobeads of varying size and composition, and as such possibly varying weight and magnetic attraction. The magnetic field can be controlled to be on or off at the tip of the quill while the quill is in the retracted or extended positions, or in any position between them.

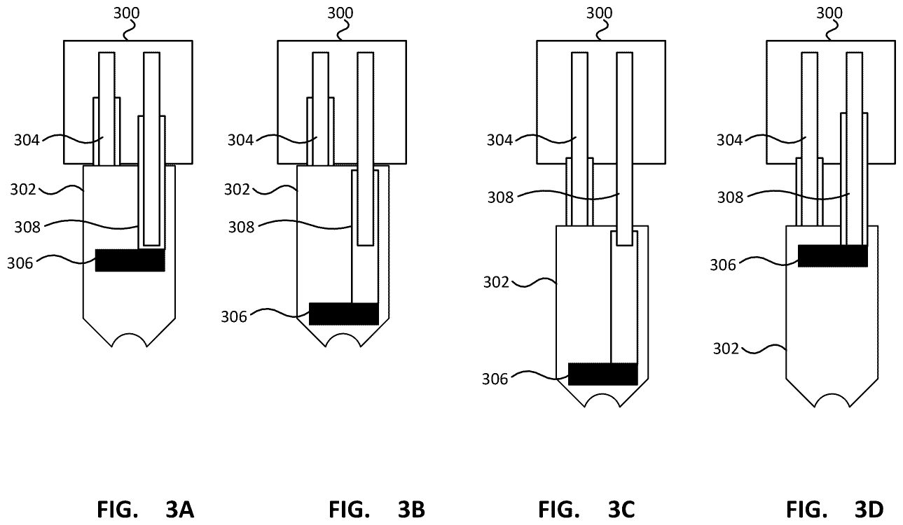

FIG. 3A-3D depict a further magnetic moveable quill. While the electric magnet quill described with reference 2A, 2B can provide various advantageous such as a controlled varying magnetic field strength, the arrangement may be difficult to incorporate into certain applications reliably. The magnetic moveable quill 300 depicted in FIGS. 3A-3D may be used in place of the magnetic moveable quill 200 described above. Similar to the magnetic moveable quill 200, the magnetic moveable quill 300 comprises a quill 302 mounted to an actuator that can retract the quill as depicted in FIGS. 3A, 3B and extend the quill as depicted in FIGS. 3C, 3D. Instead of using an electric magnet as described above, the magnetic moveable quill 300 uses a moveable permanent magnet 306 attached to a linear actuator 308. The magnet 306 can be away from the tip as depicted in FIGS. 3A, 3C such that the magnetic force at the quill is not sufficient to retain a lyobead on the quill. The magnet 306 can be move toward the quill tip as depicted in FIGS. 3B, 3C such that the magnetic force at the quill will be sufficient to retain the lyobead on the quill. The linear actuator 308 used to move the magnet 306 may controlled electrically, pneumatically, or hydraulically. The strength of the magnetic force at the tip of the quill can be varied by adjusting the proximity of the magnet 306 to the tip.

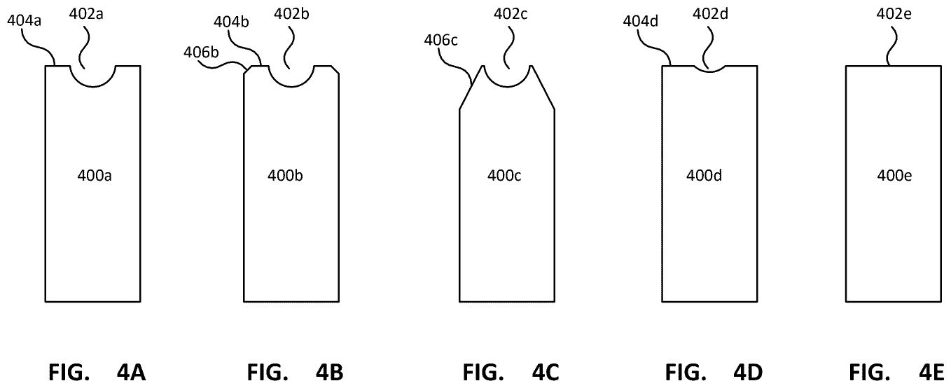

FIG. 4A-4E depict different profiles of a quill. The quill may have a generally cylindrical shape with the profiles depicted in FIGS. 4A-4E showing a central cross section. Other shapes of quills may be used. The quill tip shapes depicted in FIGS. 4A-4E may be used for the upper and/or lower quills described above. As depicted in FIG. 4A, the tip of the quill 400a may have a hemispherical depression 402a on a generally flat surface 404a. The depression 402a is generally sized according to the size of the lyobeads the quill will be used with. The lyobeads can be partially received with in the hemispherical depression 402a and retained in the depression by way of a magnetic force. Additionally, or alternatively, the lyobead may be retained in the depression by way of gravity, for example in the case of the lower quill. While the shape of the quill tip depicted in FIG. 4A may successfully capture a single lyobead in the depression when extending through a singulation bowl, the flat top 404a may allow one or more additional lyobeads to be captured on the top of the quill, which could interfere with the transfer of the lyobead to another quill.

The flat top 404a of the quill 400a may be reduced as depicted in FIG. 4B. While a flat portion 404b remains on the top surface surrounding a hemispherical depression 402b, it is reduced by an angled profile 406b. The angled profile 406b can reduce the likelihood of additional lyobeads being retained on the quill tip. As depicted in FIG. 4C, the angled profile 406c may be extended to the edge of the hemispherical depression 402c to further reduce the likelihood of additional lyobeads being retained on the quill tip.

The quills 400a, 400b, 400c depicts in FIGS. 4A, 4B, 4C are depicted with a similarly sized hemispherical depression 402a, 402b, 402c. It is possible for the size to be larger or smaller. The quill 400d depicts a flat top quill 400d, similar to quill 400a, with a shallow hemispherical depression 402d. It will be appreciated that the different sized depressions may be used with quills similar to those depicted in FIGS. 4B, 4C, such as a cone or tube shape.

FIG. 4E depicts a further quill shape 400e in which the depression is absent entirely. The top of the quill 400e is flat 402e. With the flat top quill, the lyobeads may rest on the flat surface and be retained by magnetic force. The width of the quills described above may be reduced, which may reduce the number of lyobeads resting on the flat surface.

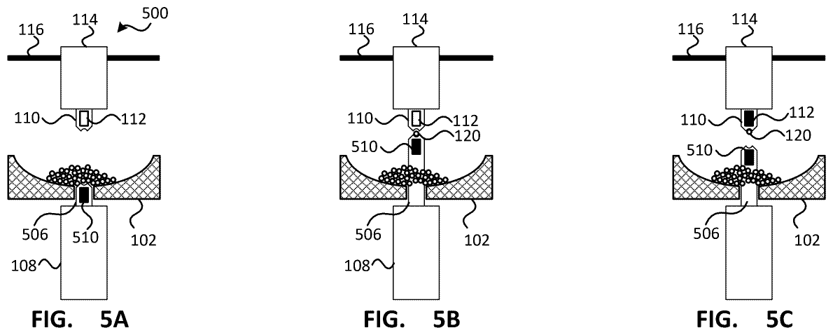

FIG. 5A-5C depict a system and operation for handling of ferromagnetic lyobeads with a magnetic lower quill. The system 500 is similar to the system 100 described above with reference to FIG. 1A-1F, and only the differences are described in further detail. The lower quill 506 of the system 500 has a magnet 510. The magnet 510 is depicted as a permanent magnet. The magnet 510 helps with retaining a lyobead on the lower quill. The profile of the quill, and the strength of the magnet force, can be adjusted so that the magnetic force at the angled profile of the tip is not sufficient to retain lyobeads on the angled portion, but provides a sufficient retaining force to the single lyobead captured on the tip. As the tip extends through the singulation bowl as depicted in FIG. 5B, the magnetic force retains the lyobead 120 on the tip of the lower quill as it approaches the upper quill 110. Once the lyobead 120 is in close proximity to, or in contact with, the upper quill, the controllable magnet 112 can be controlled to provide a sufficient magnetic force at the tip to retain the lyobead 120 on the upper quill. The magnetic force required may be greater than that of the system 100 in which the lower quill does not have a magnet. That is, the magnetic force provided by the controllable magnet at the upper quill needs to be sufficient to overcome both the force of gravity and the force of the magnet 510 of the lower quill 506 acting on the lyobead.

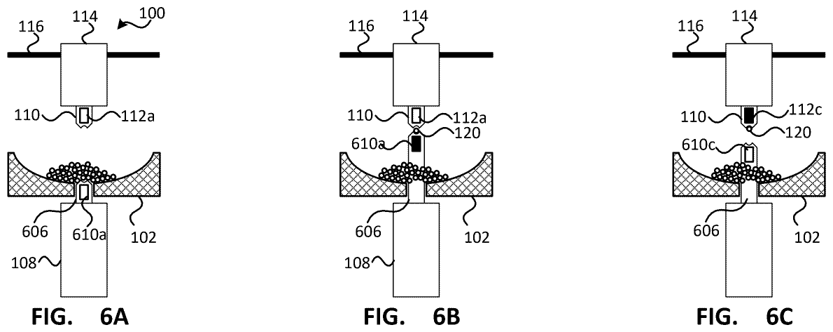

FIG. 6A-6C depict a system and operation for handling of ferromagnetic lyobeads with a magnetic lower quill. The system 600 is similar to the system 500 described with reference to FIGS. 5A-5C, however rather than including a fixed magnet 512, the system 600 comprises a controllable magnet in the lower quill. As depicted in FIG. 6B, the controllable magnet 610 of the lower quill 606 may be activated, as depicted by the solid black magnet 610, as the quill extends above the singulation bowl towards the upper quill 110. The controllable magnet 610 helps to retain the lyobead 120 in place on the lower quill as it extends into close proximity or contact with the upper quill. With The lyobead in proximity to or contact with the upper quill, the controllable magnet 610 of the lower quill can be reduced or turned off and the controllable magnet 112 of the upper quill can be turned on controlled to increase the strength of the magnetic field at the tip. The lyobead is transferred to and retained on the upper quill with the magnet of the upper quill on, and the magnet of the lower quill off as depicted in FIG. 6C.

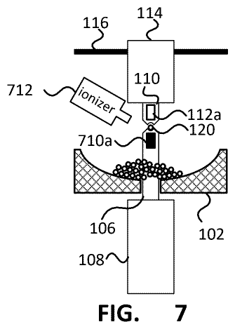

FIG. 7 depicts a further system for handling of ferromagnetic lyobeads. The system of 700 is similar to the systems 100, 500, 600 described above; however the system 700 includes an ionizer 712. As described above, the lower quill may repeatedly extend and retract through a singulation bowl with a plurality of lyobeads. The repeated extension/retraction through the lyobeads may generate a static charge on the lyobeads and/or the quill that can tend to cause additional lyobeads to stick to the quill. In order to reduce the static charge an ionizer 712 may be used to blow on or towards the lower quill. In addition to reducing the static charge, the ionizer's air stream may also tend to blow off additional lyobeads that are statically attached to the quill. The placement of the ionizer may be arranged so that the stream is directed toward the lower quill when it is in a position close to the upper quill.

Although described as being an ionizer, it is possible to replace the ionizer with an air stream directed at the lower quill in order to blow additional lyobeads off of the lower quill.

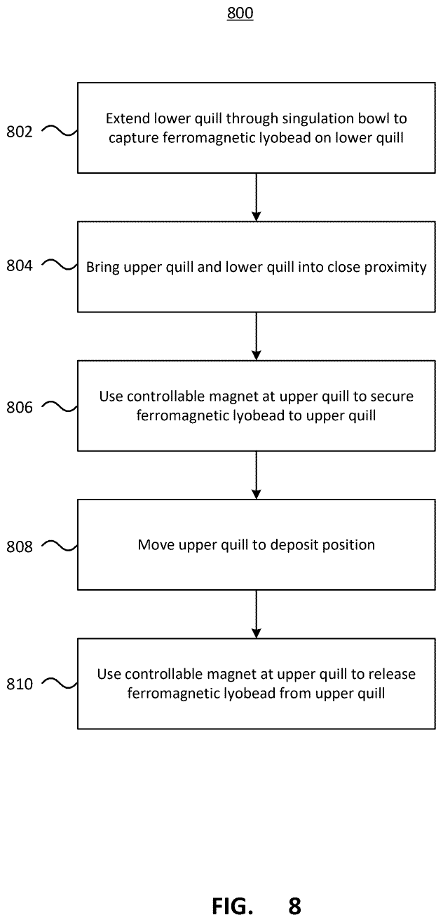

FIG. 8 depicts a method for handling of ferromagnetic lyobeads. The method 800 can control a magnetic lyobead handling system such as that described above. The method may be implemented by one or more controllers. The method 800 extends a lower quill through a singulation bowl (802) that holds a plurality of lyobeads. As the lower quill is extended through the lyobeads, one of the lyobeads is captured on the lower quill. The lower quill, with the lyobead is brought into close proximity to the upper quill (804). Once in close proximity, a controllable magnet at the upper quill is controlled (806) in order to retain the lyobead on the upper quill. With the lyobead transferred to the upper quill and retained by the magnetic force, the upper quill can be moved to a deposit position (808). Once arranged at the deposit position, the magnet can be operated in order to release the lyobead from the upper quill (810).

The above has described the use of an upper and lower quill for the singulation and control of lyobeads. While a single pair of upper/lower quills may be used as described above, it is possible to include additional upper quills and/or lower quills.

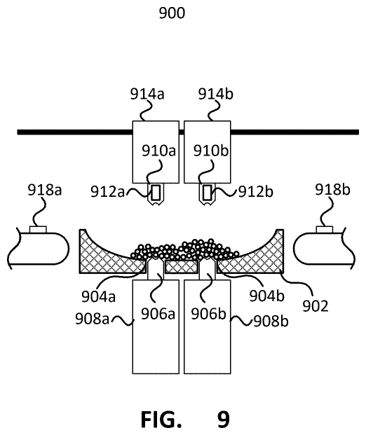

FIG. 9 depicts a further system for handling ferromagnetic lyobeads. The system 900 is depicted as having two pairs of upper and lower quills. The system 900 is similar to those described above. A singulation bowl 902 holds plurality of lyobeads. The singulation bowl 902 includes two openings 904a, 904b through which respective lower quills 906a, 906b can be extended. The lower quills 906a, 906b can be extended and retracted through the respective openings 904a, 904b by actuators 908a, 908b. Thee actuators 908a, 908n can be individually controlled, or controlled together, in order to extend and retract the lower quills 906a, 906b through the openings 904a, 904b and capture an individual lyobead on each of the lower quills. Although not depicted in FIG. 9, it is possible for the individual lower quills 906a, 906b, to include a magnet as described above with reference to FIG. 5A-6C. Regardless of whether the lower quills include a magnet, the lower quills can raise a lyobead from the singulation bowl towards a respective one of the upper quills 910a, 910b. The upper quills 910a, 910b each include selectable magnets 912a, 912b that can be controlled in order to turn on and turn off a magnetic field at the tip of the quill that is sufficient to retain a lyobead against the tip. The controllable magnets 912a, 912b can be controlled in order to transfer a lyobead from the lower quills to the upper quills. The upper quills may each include respective actuators 914a, 914b for controlling movement of the upper quills 910a, 910b. The upper quills can be moved to respective transfer locations 918a, 918b and can deposit the respective lyobeads to the respective transfer locations.

FIG. 9 depicts a system with two pairs of upper and lower quills, which may effectively double the throughput of the system. Other arrangements of upper and lower quills are possible. For example, multiple upper quills may be used with a single lower quill. Such an arrangement could be beneficial if the cycling time of the upper quills is longer, or possible significantly longer, than the cycling time of the lower quill. It will be appreciated that the cycle time is considered to be the time necessary to perform an action and return to a starting position. For the upper quill, this may be the length of time from transferring a lyobead from the lower quill, moving to the transfer location, depositing the lyobead and returning to the initial location above the lower quill. For the lower quill, the cycle time may be the length of time to retract from a position extended up through the singulation bowl, and extend again through the singulation bowl. Alternatively, if the cycle time of the lower quill is longer, and possibly significantly longer, than the cycle time of the upper quill, multiple lower quills may be used with a single upper quill.

The lyobead singulation and handling systems described above can be used in various applications including in research and development, testing and/or verification, manufacturing, assembly, and packing.

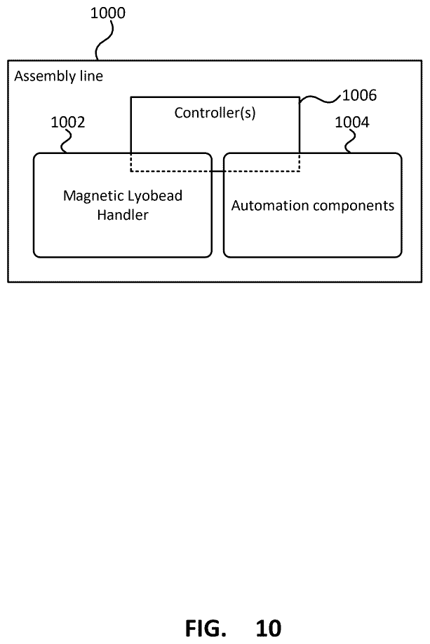

FIG. 10 depicts an assembly line system incorporating a magnetic lyobead handler. The system is depicted as an assembly line 1000 for manufacturing a component that comprises a lyobead. The assembly line 1000 includes one or more magnetic lyobead handlers 1002, which may be a lyobead handler as described above. A plurality of lyobeads can be filled in the singulation bowl, or bowls of the magnetic lyobead handler 1002 and then individual lyobeads placed in a particular location, which could be for example within a package or other component being assembled. The assembly line 1000 may also include one or more additional automation components 1004 which may perform various processes, either before or after the magnetic lyobead handler. The assembly line 1000 also includes one or more controllers 1006 that control the operation of the assembly line and individual components. The controller(s) 1006 may comprise one or more processors, microprocessors, microcontrollers, controllers, application specific integrated circuits and/or field programmable gate arrays. If the assembly line includes multiple controllers, they may be in communication with each other, or at least one other controller. For example, the magnetic lyobead handler 1002 and the automation components may include their own controllers and may be in communication with an overall controller of the assembly line that can coordinate the operation of the individual controllers. Further, although depicted as being provided within the assembly line, one or more of the controllers 1006 may be provided at locations that are remote from the assembly line. When there are multiple controllers, they may communicate with each other using wired and/or wireless communications.

It will be appreciated by one of ordinary skill in the art that the system and components shown in FIG. 1-10 may include components and/or steps not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Although certain components and steps have been described, it is contemplated that individually described components, as well as steps, may be combined together into fewer components or steps or the steps may be performed sequentially, non-sequentially or concurrently. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the components and processes described herein may be provided by various combinations of software, firmware and/or hardware, other than the specific implementations described herein as illustrative examples.

The techniques of various embodiments may be implemented using software, hardware and/or a combination of software and hardware. Various embodiments are directed to apparatus, e.g. a node which may be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor may be for use in, e.g., a communications device or other device described in the present application.

Numerous additional variations on the methods and apparatus of the various embodiments described above will be apparent to those skilled in the art in view of the above description. Such variations are to be considered within the scope.

1. A handling system for ferromagnetic lyobeads comprising:
a singulation bowl for holding a plurality of ferromagnetic lyobeads, the singulation bowl comprising an opening in a bottom of the singulation bowl;
a lower quill arranged to pass through the opening of the singulation bowl and comprising a tip shaped to allow a ferromagnetic lyobead of the plurality of ferromagnetic lyobeads in the singulation bowl to rest on the tip when the lower quill passes through the opening of the singulation bowl; and
an upper quill comprising:
a tip shaped to at least partially contact the ferromagnetic bead on the lower quill; and
a controllable magnet within the tip that is controllable to provide a magnetic force at the tip of the upper quill that can retain the ferromagnetic lyobead against the tip of the upper quill.

2. The handling system of claim 1, further comprising a first actuator for moving the tip of the upper quill along a first axis.

3. The handling system of claim 2, wherein the first axis is towards/away the lower quill.

4. The handling system of claim 2, wherein the first actuator comprises a linear actuator.

5. The handling system of claim 2, further comprising a second actuator for moving the upper quill along a second axis.

6. The handling system of claim 5, wherein the second axis moves the upper quill away/towards the lower quill.

7. The handling system of claim 1, wherein the lower quill comprises a magnet capable of providing a magnetic force tending to retain the ferromagnetic lyobead on the top of the lower quill.

8. The handling system of claim 7, wherein the magnet of the lower quill is controllable to vary the strength of the magnetic field at the top of the lower quill.

9. The handling system of claim 1, wherein the controllable magnet of the upper quill comprises an electromagnet arranged in the tip of the upper quill.

10. The handling system of claim 1, wherein the controllable magnet of the upper quill comprises a moveable permanent magnet moveable towards/away from the tip of the upper quill.

11. The handling system of claim 10, further comprising a linear actuator for moving the permanent magnet in the upper quill.

12. The handling system of claim 1, further comprising an ionizer arranged to direct an air flow towards the ferromagnetic lyobead when captured on the lower quill.

13. A quill for use in an automated handling system of ferromagnetic lyobeads, the quill comprising:
a tip shaped to contact at least part of a ferromagnetic lyobead; and
a controllable magnet arranged to provide a variable strength magnetic field at the tip, the magnetic field variable between:
a first strength sufficient to retain the ferromagnetic lyobead in contact with the tip; and
a second strength insufficient to retain the ferromagnetic lyobead in contact with the tip.

14. The quill of claim 13, wherein the controllable magnet comprises an electromagnet arranged in the tip of the quill.

15. The quill of claim 13, wherein the controllable magnet comprises a moveable permanent magnet moveable towards and away from the tip of the quill.

16. The quill of claim 15, further comprising a first linear actuator for moving the permanent magnet towards and away from the tip of the quill.

17. The quill of claim 16, further comprising a second linear actuator for moving the tip along a first axis.

18. A method of controlling an automated handling system for
ferromagnetic lyobeads, the method comprising:
controlling a lower quill of the automated handling system to pass through a singulation bowl of the handling system in order to capture a ferromagnetic lyobead within the singulation bowl on a top of the lower quill;
bring the lower quill with the ferromagnetic lyobead into close proximity with an upper quill of the automated handling system;
controlling a magnet of the upper quill of the automated handling system to provide a magnetic force at the tip of the upper quill sufficient to retain the ferromagnetic lyobead on the upper quill;
moving the upper quill to a deposit position; and
controlling the magnet of the upper quill to reduce the strength of the magnetic field in order to release the ferromagnetic lyobead from the upper quill.

19. The method of claim 18, further comprising:
controlling a magnet of the lower quill to retain the lyobead on the lower quill and release the ferromagnetic lyobead from the lower quill.

20. (canceled)
